(19) United States
(12) Patent Application Publication
(10) Pub. No.: US 2020/0063304 A1
(43) Pub. Date: Feb. 27, 2020

(54) PROCESS FOR PRODUCING SEMI-PROCESSED PRODUCT FOR AUTOMOBILE EQUIPMENT

(71) Applicant: UNITIKA LTD., Amagasaki-shi, Hyogo (JP)

(72) Inventors: Kazutoshi HANAYA, Osaka-shi, Osaka (JP); Toru TAKAHASHI, Okazaki-shi, Aichi (JP); Hideaki KAMINOKADO, Osaka-shi, Osaka (JP); Masaya AKAO, Chuo-ku, Tokyo (JP); Yusuke NAGATSUKA, Okazaki-shi, Aichi (JP)

(21) Appl. No.: 16/466,142

(22) PCT Filed: Dec. 12, 2017
(86) PCT No.: PCT/JP2017/044478

§ 371 Date: Jun. 3, 2019

(30) Foreign Application Priority Data
Dec. 13, 2016 (JP) 2016-241154

(51) Int. Cl. D04H 1/46; D04H 1/4382; B62D 25/20; D01F 8/14; B62D 29/04

(52) U.S. Cl. CPC D04H 1/46; D04H 1/4382; D10B 2505/12; D01F 8/14; B62D 29/04; B62D 25/20

(57) ABSTRACT

Provided is a method for producing a semi-product for automobile equipment, the semi-processed product being moldable in a relatively broad range of heating temperatures and being capable of obtaining a final product with high stiffness. In the method for producing a semi-processed product for automobile equipment, needle punching is performed on a fiber web in which core-sheath composite fibers are accumulated, and the core-sheath composite fibers are three-dimensionally interlaced together. The core portion of the core-sheath composite fibers comprises a copolymer of ethylene glycol and terephthalic acid. The sheath portion of the core-sheath composition fibers comprises a copolymer including ethylene glycol, adipic acid and terephthalic acid. The weight ratio of core portion to sheath portion in the core-sheath composite fibers is 1 to 3:1. The core portion and the sheath portion are disposed concentrically. In the fiber web, the core-sheath composite fibers are bonded together by softening or melting the sheath portion.

### TECHNICAL FIELD

The present invention is related to a process for producing a semi-processed product suitable for obtaining automobile equipment, such as an automobile exterior parts, and in particularly to a process for producing the semi-processed product excellent in moldability and hardness after molding.

### BACKGROUND ART

There have been many exterior parts equipped with automobiles. For example, an automobile is equipped with an undercover covering an underside of an automobile or a tire house cover covering inside a tire house. The undercover is equipped for improving air flow flowing under an automobile to reduce air resistance and to enhance fuel efficiency. It also prevents an underside of an automobile from damaging by stone chipping while the automobile is traveling and reduces sounds emitted by stone chipping. The tire house cover prevents an inside of a tire house from damaging by gravels rolling up with the tires while the automobile is traveling and reduces sounds emitted by gravels rolled up.

The undercover and tire house cover are prepared by shaping semi-processed products, such as synthetic resin sheet or synthetic resin fabric to a shape of the automobile. For example, Patent Literature 1 discloses an undercover which is produced by heating and compress-shaping a semi-processed product being a needle-punched non-woven fabric formed from thermoplastic synthetic staple fiber. (see claim 1 of Patent Literature 1). The Literature 1 mentions that the thermoplastic synthetic staple fiber can be a polypropylene fiber or a polyester fiber. When they are employed for heating and press-shaping, a temperature range should be narrowly controlled so as to request sever temperature controlling. Even compress-shaping does not produce a shaped article with high rigid.

### CITATION LIST

### Patent Literature

[PTL 1]

WO 2012/164977 A

### SUMMARY OF INVENTION

### Technical Problem

The present invention is to provide a semi-processed product for automobile equipment, which can be shaped or molded in a relatively broad temperature range and can produce a final shaped article having enhanced rigidity.

### Solution to Problem

The present invention dissolves the above problem by using a specific fiber as the fiber which constitutes a semi-processed product of non-woven fabric. Thus, the present invention provides a process for producing a semi-processed product for automobile equipment, comprising needle-punching a fiber web in which core-sheath composite fibers are accumulated and the core-sheath composite fibers are three dimensionally interlaced together, wherein the core portions of the core-sheath composite fibers comprise a copolymer of ethylene glycol and terephthalic acid and the sheath portions comprise a copolymer including ethylene glycol, adipic acid and terephthalic acid.

In the present invention, a fiber web which comprises specific core-sheath composite fibers as constituting fiber is obtained. In this context, the specific core-sheath composite fiber is composed of a core portion comprising a copolymer of ethylene glycol and terephthalic acid and a sheath portion comprising a copolymer of polyethylene glycol, adipic acid and terephthalic acid. The copolymer for the core portion is a polyester which is obtained by a dehydration condensation of ethylene glycol as a diol component and terephthalic acid as dicarboxylic acid. The dicarboxylic acid may contain a very small amount of another dicarboxylic acid, such as isophthalic acid and the like. The copolymer constituting the core portion preferably has a melting point of about 260° C. and a glass transition temperature of about 70 to 80° C. The copolymer constituting the sheath portion can be a polyester copolymer which is obtained by a dehydration condensation of ethylene glycol as a diol component and adipic acid and terephthalic acid as a dicarboxylic acid. A mixing ratio of adipic acid and terephthalic acid as dicarboxylic acid is not limited, but it is preferably in a range of 1:1 to 10 (molar ratio) of adipic acid:terephthalic acid. It is preferred that the diol component contains a small amount of diethylene glycol. An amount of diethylene glycol can be within a range of 0.5 to 5.0 mole % in the diol component. In addition, it is preferred that the dicarboxylic acid contains a small amount of isophthalic acid. An amount of isophthalic acid can be within a range of 2.0 to 5.0 mole % in the dicaboxylic acid. The addition of diethylene glycol or isophthalic acid in a small amount can adjust rigidity of fiber obtained. The copolymer constituting the sheath portion preferably has a melting point of about 200° C. and a glass transition temperature of about 40 to 50° C.

A weight ratio of the core portion and the sheath portion can preferably be within the range of 0.3 to 3:1 (weight ratio) of core portion:sheath portion. If the weight ratios of the core portion are too low, shape retention would reduce when heating and the final automobile equipment is poor in strength and rigidity. If the weight ratios of the core portion are too high, shaping is difficult when heating and compression molding, and a surface would easily fluff up. The core portion can either be concentric or eccentric to the sheath portion, but preferred is concentric. If it is eccentric, contraction would occur when heating and compression-molding and would not be preferred.

The core-sheath composite fiber can be produced by a known method wherein a polyester of the core portion and a polyester of the sheath portion are provided into a spinning apparatus having composite spinning holes and are melt-spun. The core-sheath composite fiber can either be core-sheath composite continuous fiber or core-sheath staple fiber, but core-sheath composite continuous fiber is preferred because it provides high rigid automobile equipment. The fiber web obtained from core-sheath composite continuous fiber may generally be obtained by so-called spun bond method. Core-sheath composite continuous fiber obtained by melt spinning is collected in a form of a sheet to obtain a fiber web. For obtaining a fiber web from core-sheath composite staple fiber, core-sheath composite staple fibers are passed through a carding machine to open fibers and to correct in a form of a sheet. A weight of the fiber web may be within a range of 200 to 2,000 g/m². When the weights of the fiber web are too low, it is not suitable for automobile equipment and when they are too high, the resulting automobile would become high weight and fuel efficiency would be poor.

The fiber web can be needle-punched either in the core-sheath composite fibers not bonded or bonded with each other. It is preferred that they are not bonded, because needle-punching hardly damages the fibers and scarcely raises the reduction of strength because of the fibers not bonded. In the case where the core-sheath composite fibers are bonded, they are easily treated and easily conveyed. The needle punching can be conducted by art-known methods. The needle punching makes the core-sheath composite fibers three dimensionally interlaced to produce closely interlaced semi-processed products. Even if the fibers are bonded, the needle punching generally destroys the bonding and three dimensionally interlaces with each other. Punching density can preferably be 10 punches or more/cm².

The thus-obtained semi-processed product for automobile equipment is heated and compress-molded to form automobile equipment. In the present invention, heating temperature can preferably be within the range of 120 to 220° C. When it is compressed, it is preferred that any pressures can be selected based on the degree of compression. A time for heating and compression molding can preferably be within the range of 5 to 60 seconds or the like. After heating and compression molding the semi-processed product, it is allowed to leave at room temperature to solidify the sheath portion of the core-sheath composite fibers constituting the semi-processed product, thus bonding the fibers closely to provide automotive equipment having excellent rigidity. The automotive equipment includes an undercover, a tire house cover, a roof material, a dashboard silencer, a hood silencer, a fender liner, a floor material (such as a carpet) or a tray for automobiles. It can also be used for a filter, a transpiration board for a humidifier, an acoustic absorbent (an anti-noise material), an interior good, a primary cloth for a tufted carpet or a board for many applications, although they are not applied to automobiles.

### Advantageous Effects of Invention

The semi-processed product for automobile obtained by the process of the present invention is formed from a core-sheath composite fiber of which the sheath portion is formed from a copolymer comprising ethylene glycol, adipic acid and terephthalic acid. The use of adipic acid as a component of the copolymer reduces a melting point of the sheath portion to as low as around 200° C. or the like, which provides with excellent technical effects, such as it can be heated and compression molded at a broad temperature range. Since the sheath portion has a low melting point, it can provide automobile equipment having high rigidity. In the case where the core-sheath composite fiber is continuous fiber, the automotive equipment has higher rigidity in addition to the low melting point of the sheath portion.

### EXAMPLES

### Example 1

A copolymer having a melting point of 250° C. was prepared from ethylene glycol and terephthalic acid as a core portion. Another copoymer having a melting point of 200° C. was prepared from ethylene glycol, diethylene glycol, adipic acid, terephthalic acid and isophthalic acid as a sheath portion. The diol components contained 98.8 mole % of ethylene glycol and 1.2 mole % of diethylene glycol. The dicarboxylic acid components contained 18.8 mole % of adipic acid, 78.0 mole % of terephthalic acid and 3.2 mole % of isophthalic acid. Both of the core portion and the sheath portion were put in a spinning machine having composite spinning holes and melt-spun to obtain core sheath composite continuous fibers. A weight ratio of core portion and sheath portion was core portion:sheath portion=7:3. After obtaining the core sheath composite continuous fibers, they were introduced into an air sucker equipped with a lower portion of the spinning machine and high speed drawn and thinned, followed by fiber opening using an art-known fiber opening apparatus and collecting them on a moving screen conveyer to obtain a fiber web. The resulting fiber web was provided between a pair of heating rolls to soften the sheath portions, thus bonding the core sheath composite continuous fibers together, which were moved to a needle punch machine and needle punched with a punch density of 90 punches/cm² to obtain a semi-processed product for automotive equipment having a weight of 525 g/m².

### Comparative Example 1

The copolymer obtained in Example 1 was prepared as the core portion. A terpolymer having a melting point of 230° C. formed from ethylene glycol, terephthalic acid and isophthalic acid was prepared. Both of the core portion and the sheath portion were put in a spinning machine having composite spinning holes and melt-spun to obtain core sheath composite continuous fibers. A weight ratio of core portion and sheath portion was core portion:sheath portion=6:4. After obtaining the core sheath composite continuous fibers, they were introduced into an air sucker equipped with a lower portion of the spinning machine and high speed drawn and thinned, followed by fiber opening using an art-known fiber opening apparatus and collecting them on a moving screen conveyer to obtain a fiber web. The resulting fiber web was provided between a pair of heating rolls to soften the sheath portions, thus bonding the core sheath composite continuous fibers together, which were moved to a needle punch machine and needle punched with a punch density of 90 punches/cm² to obtain a semi-processed product for automotive equipment having a weight of 500 g/m².

### Comparative Example 2

A core sheath composite staple fiber (Product Number 2080 available from Unitika Co., Ltd., Fineness of 4 dtex, Fiber length of 51 mm, core portion:sheath portion=1:1, sheath portion having a melting point of 200° C.) was prepared. The core portion of the core sheath composite staple fiber was same with the copolymer employed in Example 1 and the sheath portion was a terpolymer formed from ethylene glycol, terephthalic acid and isophthalic acid, but a content of isophthalic acid was higher and its melting point was low. The core sheath staple fibers were open-fibered with a carding apparatus and collected to obtain a fiber web. The resulting fiber web was immediately moved to a needle punch machine and needle punched with a punch density of 90 punches/cm² to obtain a semi-processed product for automotive equipment having a weight of 500 g/m².

The semi-processed products for automobile equipment obtained in Example 1 and Comparative Examples 1 and 2 were passed between a pair of metal plates both heated and heated and compression molded with a pressure of 30 kPa for 1 minute. The heated metal plates were controlled to nine temperatures, i.e. 120° C., 130° C., 140° C., 150° C., 160° C., 180° C., 200° C., 210° C. and 220° C. The results are as follow: The product obtained in Example 1 could be suitably shaped at a temperature of 150 to 210° C. to obtain an accessary having high rigidity. It could be shaped at a temperature of 120 to 140° C., but its rigidity was a little poor. The semi-processed product obtained in Comparative Example 1 could not be shaped at a temperature of 120 to 180° C. and could be shaped at a temperature of 200 to 220° C., but its stiffness was poor. The semi-processed product obtained in Comparative Example 2 could be suitably shaped at a temperature of 160 to 180° C. to obtain an accessary. It could be shaped at a temperature of 120 to 150° C. or 200 to 220° C., but its rigidity was poor.

1. A process for producing a semi-processed product for automobile equipment, comprising needle-punching a fiber web in which core-sheath composite fibers are accumulated and the core-sheath composite fibers are three dimensionally interlaced together, wherein the core portions of the core-sheath composite fibers comprise a copolymer of ethylene glycol and terephthalic acid and the sheath portions comprise a copolymer including ethylene glycol, adipic acid and terephthalic acid.

2. The process according to claim 1, wherein the sheath portions comprise a copolymer of ethylene glycol, adipic acid, terephthalic acid and diethylene glycol.

3. The process according to claim 1, wherein a weight ratio of core portion:sheath portion is core portion:sheath portion=1 to 3:1.

4. The process according to claim 1, wherein the core portion and the sheath portion in the core sheath composite fiber are concentrically disposed.

5. The process according to claim 1, wherein the core-sheath composite fiber is either a core sheath composite continuous fiber or a core sheath composite staple fiber.

6. The process according to claim 1, wherein the core-sheath composite fibers are bonded together by softening or melting the sheath portions.

7. The process according to claim 1, wherein the automobile equipment is an undercover covering an underside of an automobile.

8. A process for producing automobile equipment, comprising the following steps:
a step of obtaining a fiber web in which core-sheath composite fibers are accumulated, wherein the core portions of the core-sheath composite fibers comprise a copolymer of ethylene glycol and terephthalic acid and the sheath portions comprise a copolymer including ethylene glycol, adipic acid and terephthalic acid,
a step of needle-punching a fiber web and three dimensionally interlacing the core-sheath composite fibers to obtain the semi-processed product for automobile equipment,
a step of heating and compressing the semi-processed product for automobile equipment.

9. The process for producing automobile equipment according to claim 8, wherein the sheath portion is formed from ethylene glycol, adipic acid, terephthalic acid, isophthalic acid and diethylene glycol.
